(19) United States
(12) Patent Application Publication
(10) Pub. No.: US 2023/0261520 A1
(43) Pub. Date: Aug. 17, 2023

(54) Wallet to Facilitate Charging of Mobile Device

(71) Applicant: 1Lss, Inc, Los Angeles, CA (US)

(72) Inventors: Fernando Mora, Reseda, CA (US); Alejandro Baca, Sherman Oaks, CA (US); Mydul R. Islam, Los Angeles, CA (US); Kevin H. Vuong, Baldwin Park, CA (US)

(73) Assignee: 1lss, Inc, Los Angeles, CA (US)

(21) Appl. No.: 17/672,218

(22) Filed: Feb. 15, 2022

(51) Int. Cl. H02J 50/10; H02J 50/70; H02J 50/90; H02J 7/00; A45C 1/06; A45C 15/00

(52) U.S. Cl. CPC H02J 50/10; H02J 50/70; H02J 50/90; H02J 7/0044; A45C 1/06; A45C 15/00

(57) ABSTRACT

A wallet to be connected to an electronic device to facilitate charging through the wallet. The wallet has a body defining an internal volume. The body has a first external side and a second external side and defines an ingress/egress opening on one edge of the body. The wallet exposes a charge receiving interface on one external side and a charge transmitting interface on the other external side.

### BACKGROUND

### Technological Field

Embodiments of the invention relate accessories for a mobile device. More specifically embodiments of the invention relate to a wallet that permits charging of a mobile device while the wallet remains attached thereto.

### Background

Mobile device connected wallets have become increasingly common. Because having one's wallet coupled to one's cell phone is a convenient way to keep track of both items, the commercial availability of such devices has grown dramatically with the ubiquity of smart phones. Recently, Apple Inc. of Cupertino Calif. promulgated a “MagSafe®” specification for magnetic coupling to its iPhones®. Apple has subsequently released its MagSafe® wallet that couples to its iPhones® using the MagSafe® specification.

Many state of the art smart phones enable wireless charging. Typically, the smart phone includes a receive Qi coil and supporting electronics. When the phone is placed in proximity to a Qi charger, the Qi transmit coil in the Qi charger induces a current in the receive coil that in turn charges the phone. To induce sufficient current to charge the phone, the distance between the transmit and receive coils should be a small as possible. Apple sells a Qi charger compatible with its MagSafe® specification that couples to MagSafe® compliant mobile devices. To charge the phones, the Qi charger couples magnetically directly to the MagSafe® interface on the phone or its compatible MagSafe® case. Only a single item can be connected to the phone at any time. As a result it is not possible to charge the phone with the wallet connected.

### BRIEF DESCRIPTION OF THE DRAWINGS

Embodiments of the invention are illustrated by way of example and not by way of limitation in the figures of the accompanying drawings in which like references indicate similar elements. It should be noted that different references to “an” or “one” embodiment in this disclosure are not necessarily to the same embodiment, and such references mean at least one.

FIG. 1 is a block diagram an inter-wallet charging system according to one embodiment of the invention.

FIG. 2 a block diagram an inter-wallet charging system according to another embodiment of the invention.

FIGS. 3A-3C are schematic diagrams of an inter-wallet charging system according to one embodiment of the invention.

FIG. 4 is an exploded view of a wallet according to the embodiment of FIGS. 3A-3C.

FIGS. 5A-5C are schematic diagrams of an inter-wallet charging system according to another embodiment of the invention.

FIG. 6 is an exploded view of a wallet according to the embodiment of FIGS. 5A-5C.

FIGS. 7A-7C are schematic diagrams of an inter-wallet charging system according to another embodiment of the invention.

FIG. 8 is an exploded view of a wallet according to the embodiment of FIGS. 7A-7C.

FIGS. 9A-9C are schematic diagrams of an inter-wallet charging system according to another embodiment of the invention.

FIG. 10 is an exploded view of a wallet according to the embodiment of FIGS. 9A-9C.

FIG. 11 is a schematic diagram of a wallet mobile device interconnection system according to one embodiment of the invention.

FIGS. 12A-12C are schematic diagrams showing a device side view, side view and charger side view of the wallet interconnection system of one embodiment of the invention.

FIGS. 13A-13C are schematic diagrams showing a device side view, side view and charger side view of the wallet interconnection system of another embodiment of the invention.

FIG. 14 is a schematic diagram of a charger with an interconnection system according to one embodiment of the invention.

FIG. 15 shows a device side of a wallet with a direct current interface with linear magnetic interconnections.

### DETAILED DESCRIPTION

Embodiments of the invention provide a wallet accessory for a mobile device that permits charging of the device through the wallet. That is, it is not necessary to remove the wallet from the mobile device to charge the device. The wallet provides for either wireless charging, direct charging or both.

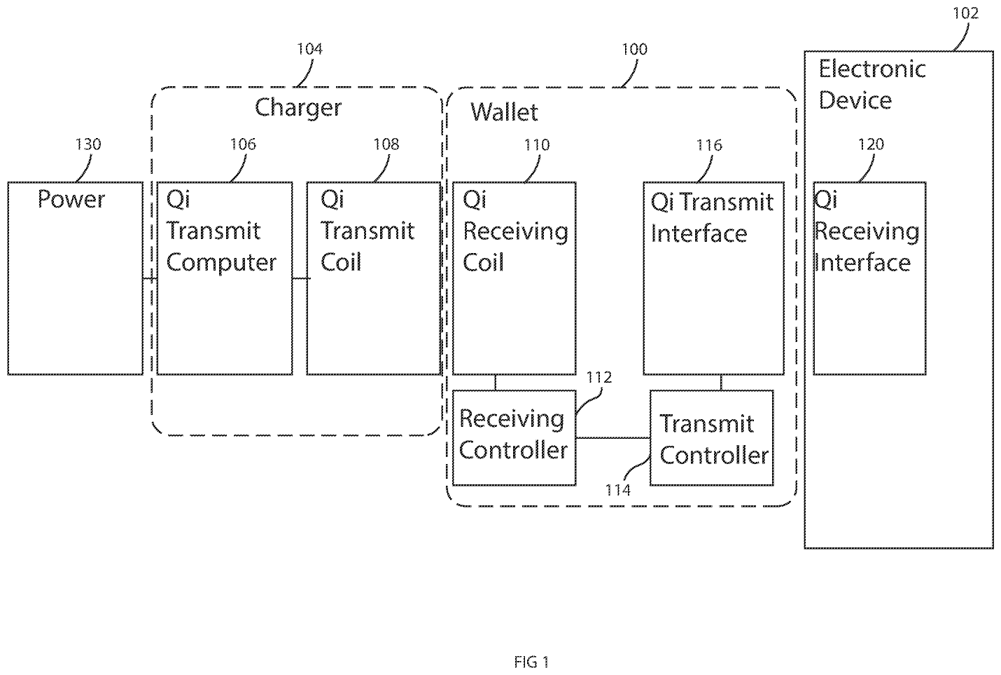

FIG. 1 is a block diagram an inter-wallet charging system according to one embodiment of the invention. A wallet 100 provides a wireless charging interface between a charger 104 and an electronic device 102. Electronic device 102 may be a smart phone, tablet, phablet, PDA or the like. Electronic device 102 contains a Qi receiving interface 120. Charger 104 can be couple to a power source 130 to power the charger 104. Power source 130 could be a fixed source such as a wall outlet or a transportable source such as a battery. In some embodiments power may be drawn from for example a USB connection or the like. Charger 104 may be a standard Qi charger containing a Qi transmit computer 106 and a Qi transmit coil 108 that is driven by the Qi transmit computer.

The wallet 100 acts as a repeater between the charger 104 and the electronic device 102. Wallet 100 includes a Qi receiving coil 110 in which the Qi transmit coil 108 induces a current when connected. A receiving controller within the wallet 100 is coupled between the receiving coil 110 and a transmit controller 114. Transmit controller 114 drives Qi transmit interface 116 within the wallet 100 to induce a current in the Qi receiving interface 120 of the electronic device 102. The induced current wirelessly charges the electronic device 102.

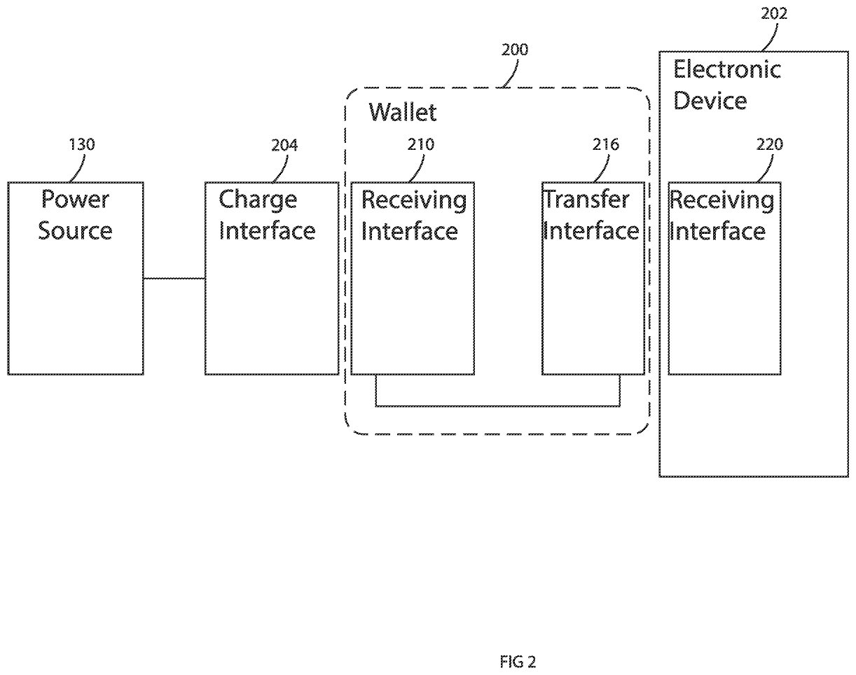

FIG. 2 a block diagram an inter-wallet charging system according to another embodiment of the invention. Electronic device 202 includes a receiving interface 220. Receiving interface 220 may or may not include a wireless charging interface. For example, receiving interface 220 may expose charging pins/pads to receive a direct current from a charger. Herein charging pins and charging pads are used interchangeably and refer to contact though which direct current can be driven to charge a device. Power source 130 may power a charge interface 204, that may or may not provide for wireless charging. Wallet 200 includes a receiving interface 210 compatible with the charge interface 204. Receiving interface is coupled to a transfer interface 216 within the wallet 200. Transfer interface 216 is compatible with receiving interface 220.

Different embodiment of the invention include various permutations of the respective interfaces. In one embodiment may be a direct current interfaces while transfer interface 216 and receiving interface 220 may be wireless interfaces, e.g., Qi interfaces. In another embodiment, transfer interface 216 and receiving interface 220 may be a direct current interfaces while charge interface 204 and receiving interface 210 may be wireless interfaces. In another embodiment, all four interfaces may be direct current interfaces. In still another embodiment, all four interfaces may be wireless interfaces as shown with respect to FIG. 1.

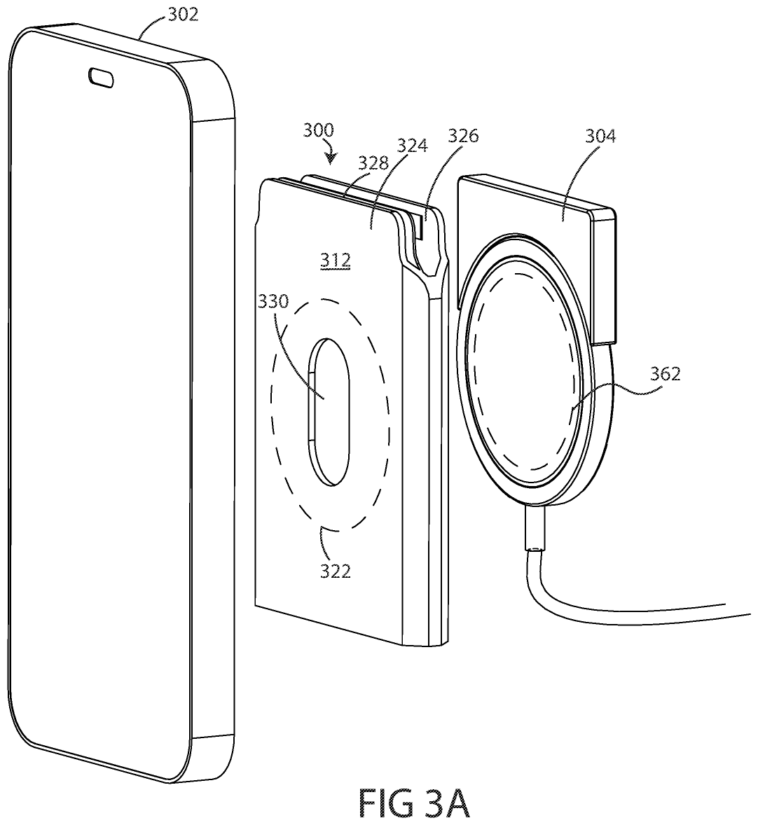

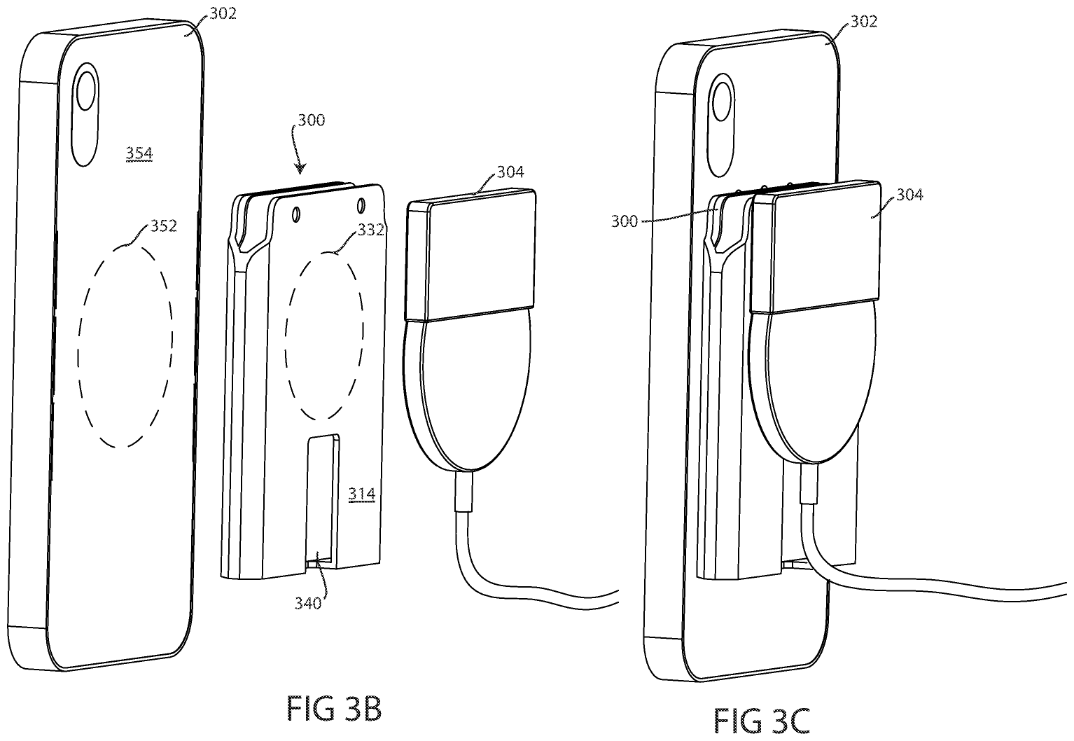

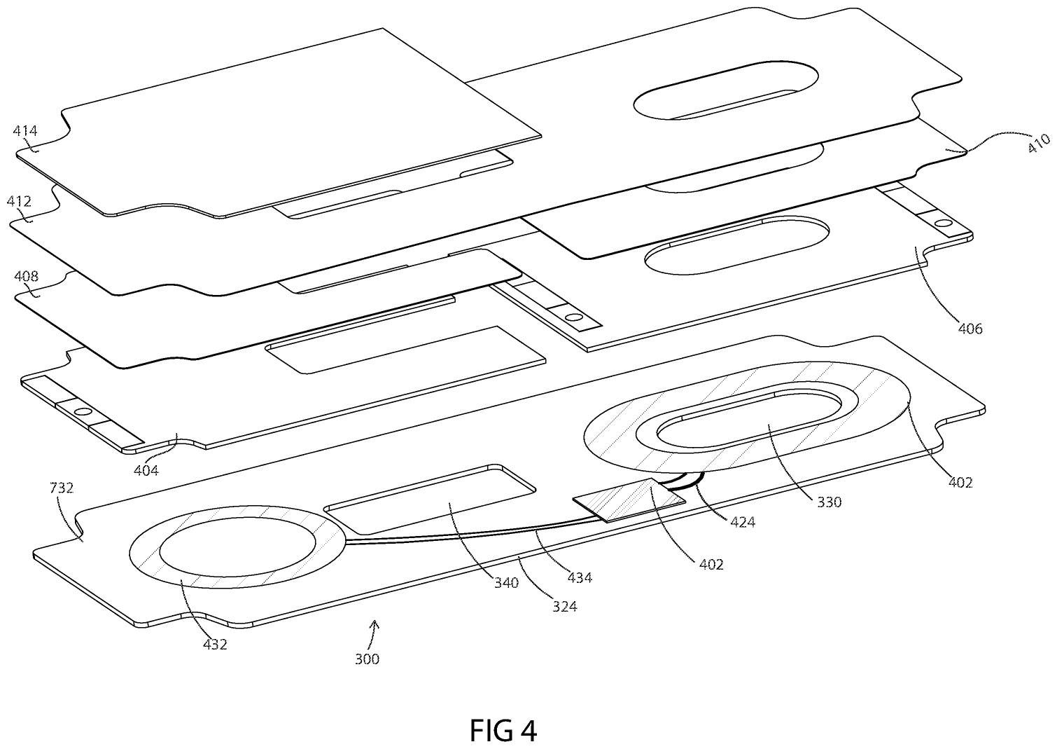

FIGS. 3A-3C are schematic diagrams of an inter-wallet charging system according to one embodiment of the invention. A mobile device 302 exposes a Qi receiving interface 352 on its surface 354. Wallet 300 has a multilayer construction described in more detail below with reference to FIG. 4. Wallet 300 has an outer body 324 with a device side surface 312 and a charger side surface 314. Outer body 324 may be formed of leather, synthetic leather, plastic, an elastomeric material or the like. Wallet 300 exposes a Qi transmit interface 322 at device side surface 312. Wallet 300 exposes a Qi receive interface 332 at charger side surface 314. A standard Qi charger 304 exposes a Qi transmit interface 362 to induce a current in the receive interface 332 of the wallet 300 when proximate thereto. Electronics (not shown in this figure) within the wallet 300 control the receive interface 332 and the flow of current therefrom to the transmit interface 322. The electronics further control the transmit interface 322 to cause it to induce a current in the receive interface 352 of the electronic device 302 when the wallet 300 is attached to the electronic device 302 and the charger 304 is powered and attached to the wallet 300. FIG. 3C shows the system in a stacked charging configuration. In this manner, the charger 304 can charge the electronic device 302 through the wallet 300 without detaching it from the electronic device 302.

Physically, outer body 324 contains an inner volume suitable to retain a number of credit cards, banknotes or the like. The outer body 324 defines an ingress/egress opening 328 into the internal volume through which the e.g., credit cards can be inserted or removed. In some embodiments, the edges of the outer body 324 taper in a region 326 adjacent to the opening 328 so that credit card edges are exposed when inside the internal volume to facilitate easier removal of the cards. In some embodiments, device side surface 312 defines a void 330 that communicates with the internal volume to allow a user to push the content of the internal volume towards the opening 328. Similarly, in some embodiments, charger side surface 314 defines a void 340 that communicates with the internal volume to allow a user to push the content of the internal volume towards the opening 328.

FIG. 4 is an exploded view of a wallet according to the embodiment of FIGS. 3A-3C. In one embodiment, wallet 300 is formed of multiple layers. Outer body 324 has a receive Qi coil 432 imbedded in or couple to an interior side of the charger side surface. Receive Qi coil 432 is coupled to a control circuit 402 by a conductive path 434 that is also coupled to or imbedded within the outer body 324. Control circuit 402 may include a Qi receive controller and a Qi transmit controller. These may be instantiated as one or more microcontrollers, one or more ASICs or the like. Transmit controller provides current modulation between the receive interface and the Qi transmit coil 422. Control circuit 402 is coupled to Qi transmit coil 422 by conductive path 424, both of which are embedded in or coupled to the outer body 324.

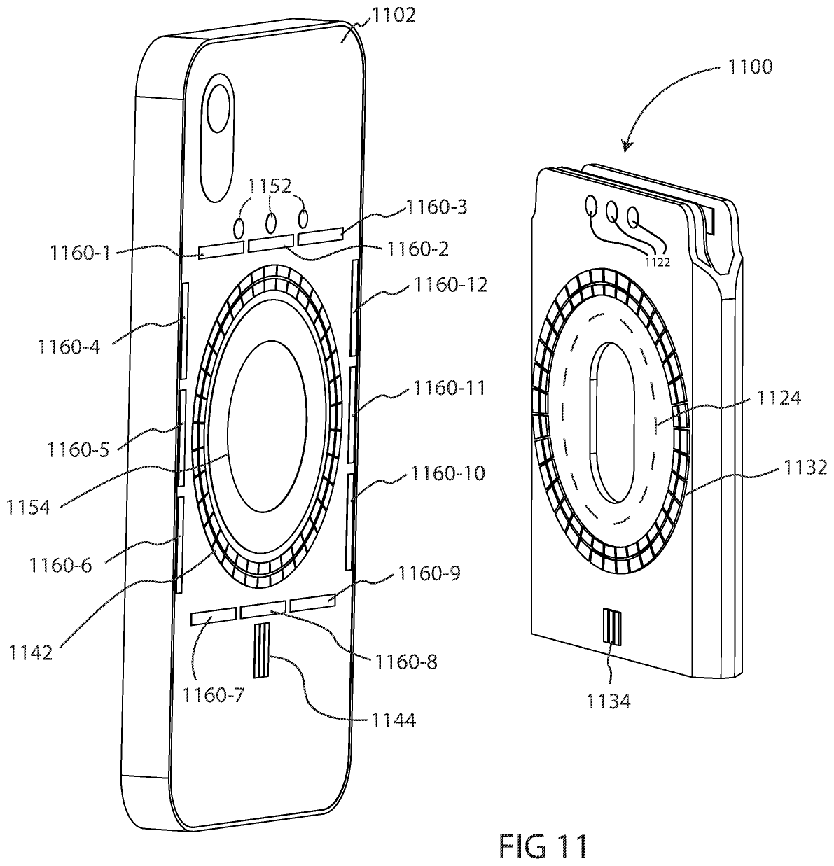

Wallet 300 includes a device side stiffening member 406 and a charger side stiffening member 404. Device side stiffening member 406 and a charger side stiffening member 404 that can provide stiffness and rigidity to wallet 300. Device side stiffening member 406 and a charger side stiffening member 404 can also provide a substrate for attaching magnetic masses to facilitate coupling between the electronic device, the wallet 300 and the charger as described in greater detail below with reference to FIGS. 11-14. Stiffening members 404, 406 can be made from materials such as plastic, cardboard, paper, metal, composites, laminates, and combinations thereof.

Device side shield 410 and charger side shield 408 provide ferromagnetic shielding for the content of the wallet 300. Device side shield 410 and charger side shield 408 protect magnetically sensitive credit cards from exposure to the magnetic fields created both by magnetic masses that may be used to couple the wallet 300 to the other constituents of the charging system and from the magnetic fields created by the receive Qi coil 432 and the transmit Qi coil 422. In one embodiment, the shields 408, 410 are ferrite shields.

Inner liner 412 resides interior to the shields 408, 410 and encloses the interior volume in which the wallet contents would reside. In some embodiments, interior liner is formed of textile material. In some embodiments, a copper infused textile material is used. A copper infused textile helps to prevent nefarious access to the cards within the wallet 300.

An optional divider 414 separates interior volume into two compartments. In some embodiments, wallet 300 includes one or more dividers. A divider 414 is a useful means to separate the credit cards from the bank notes and other contents of the wallet 300. Divider 414 can be made from materials such as plastic, cardboard, paper, metal, composites, laminates, and combinations thereof.

To assemble wallet 300, the layers may be coupled together and then the outer body 324 folded about an axis to form the internal volume. As shown, outer body 324 can be made from a single substrate and folded together, or in other embodiments, outer body 324 can be formed as distinct device side portion and a distinct charger side portion and joined together. Outer body 324 can be made from materials such as plastic, leather, composites, laminates, fabric, synthetic material, and combinations thereof.

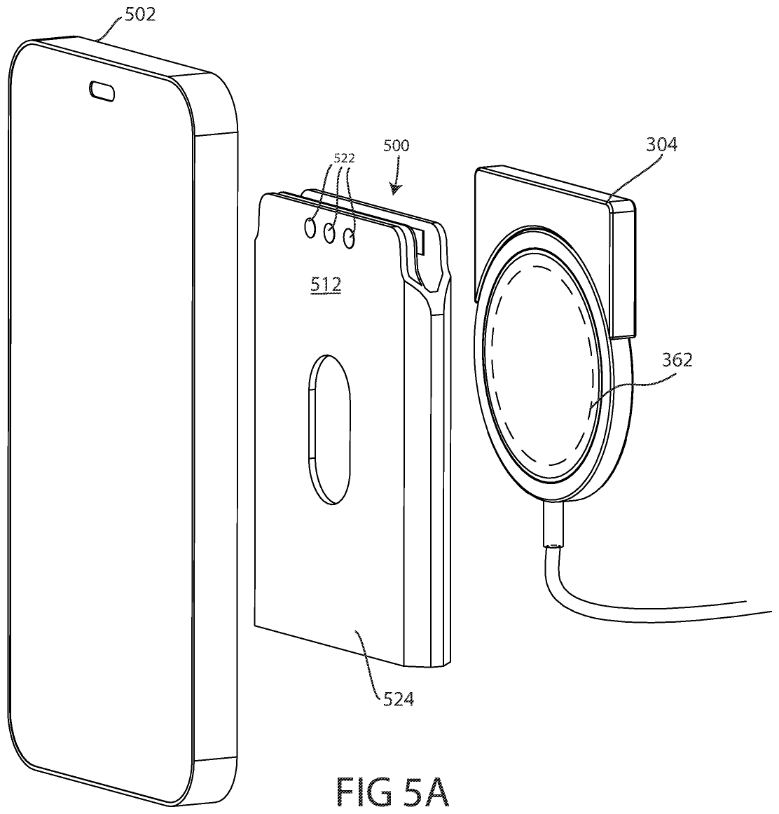

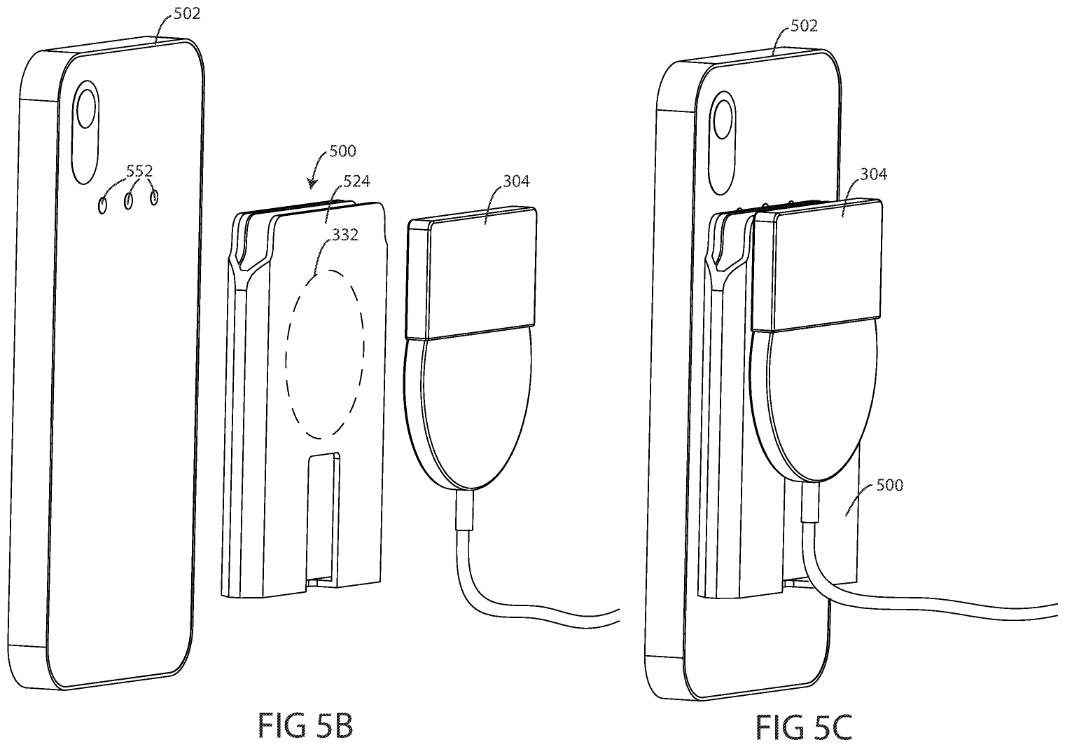

FIGS. 5A-5C are schematic diagrams of an inter-wallet charging system according to another embodiment of the invention. In some embodiments, electronic device 502 exposes a receiving interface 552 that includes a plurality of power pads on its surface. The power pads of receiving interface 552 accept a direct current to charge the internal battery of electronic device 502. Outer body 524 of wallet 500 may be formed of any of the previously describe materials. Outer body 524 exposes a corresponding set of power pads 522 of its transmit interface on its device facing surface 512 that can transmit a direct current input to the power pads 552 of the electronic device 502.

Wallet 500 exposes a Qi receive interface 532 at charger side surface 514. A standard Qi charger 304 exposes a Qi transmit interface 322 to induce a current in the receive interface 332 of the wallet 500 when proximate thereto. Electronics (not shown in this figure) within the wallet 500 control the receive interface 332 and the flow of current therefrom to the power pads 522 of the transmit interface. FIG. 5C shows the system in a stacked charging configuration. In this way, the charger 304 can charge the electronic device 502 through the wallet 500 without detaching it from the electronic device.

Physically, the wallet 500 is very similar to wallet 300 (of FIGS. 3A-4) except that the transmit interface in wallet 500 is a direct current interface rather than a Qi interface.

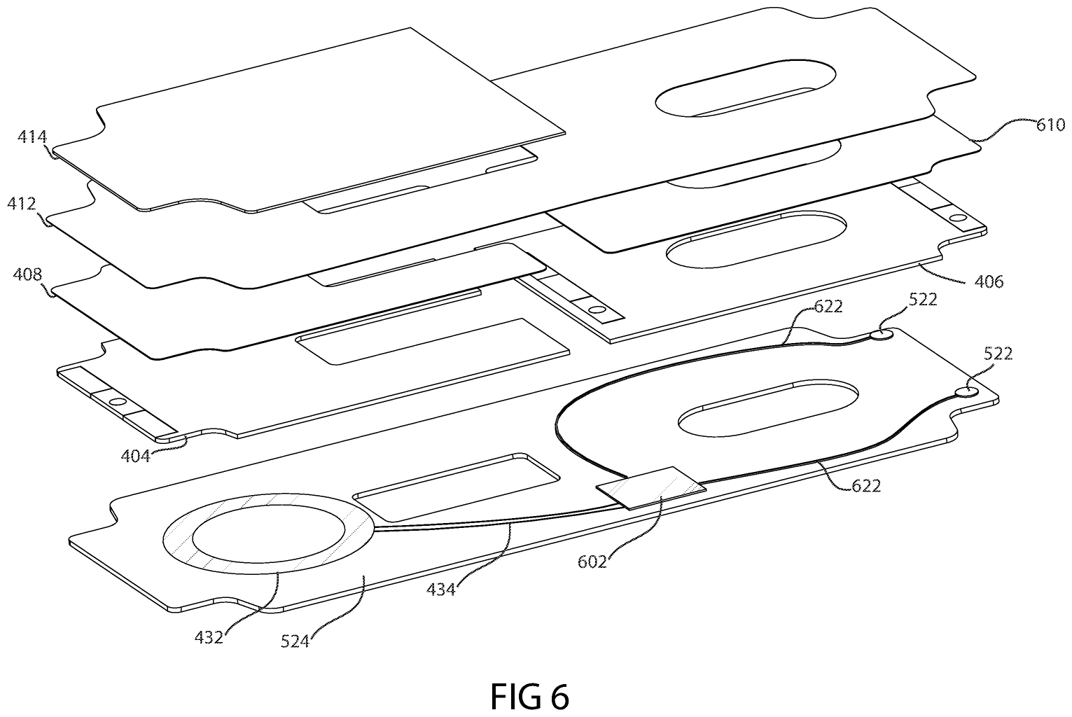

FIG. 6 is an exploded view of a wallet according to the embodiment of FIGS. 5A-5C. Like the embodiment described with reference to FIG. 4 above, this embodiment is a multilayer construction including many of the same components. The components having the same reference numbers are the same and not further described here in detail.

In one embodiment, outer body 524 has a receive Qi coil 432 imbedded in or couple to an interior side of the charger side surface. Receive Qi coil 432 is coupled to a control circuit 602 by a conductive path 434 that is also coupled to or imbedded within the outer body 324. Control circuit 602 may include a Qi receive controller, a current regulator as well as one or more charge storage devices such as capacitors or microbatteries. The controller(s) and current regulator may be instantiated as one or more microcontrollers, one or more ASICs or the like. The current regulator provides a controlled current to the power pads 522. Control circuit 602 is coupled to the power pads 522 by conductive path 622 embedded in or coupled to the outer body 524. Power pads 522 are disposed in the outer body 324 to be exposed on device facing surface 512.

The remaining layers of wallet 500 are the same as wallet 300 except that device side shield 610 need not provide the same level of ferromagnetic shielding as shield 408. The absence of a Qi transmit coil on the device side significantly reduces the risk of magnetic fields affecting the content of the internal volume. Suitable materials for device side shield 610 include metal, foil coated plastic, foil coated cardboard, carbon filled composites, and combinations thereof. In some embodiments, device side shield 602 may still be formed of the same materials as charger side shield 408. Assembly of wallet 500 is substantially the same as described above in connection with wallet 300.

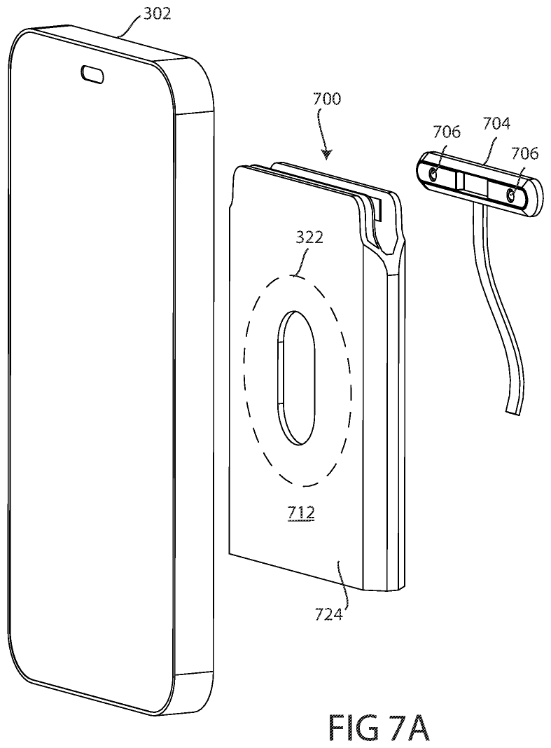

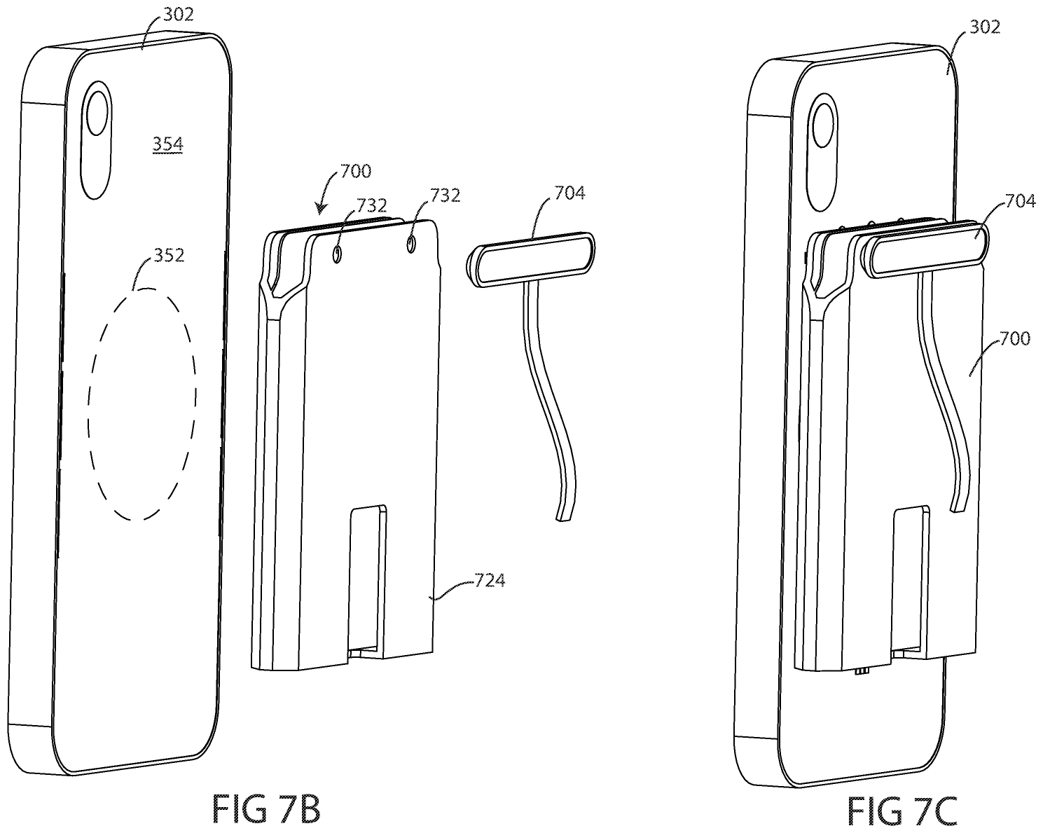

FIGS. 7A-7C are schematic diagrams of an inter-wallet charging system according to another embodiment of the invention. A mobile device 302 exposes a Qi receiving interface 352 on its surface 354. Wallet 700 has an outer body 724 with a device side surface 712 and a charger side surface 714. Outer body 724 may be formed of any of the previously describe materials. Wallet 700 exposes a Qi transmit interface 322 at device side surface 712. Wallet 700 exposes power pads 732 of its receive interface at charger side surface 714 to receive a direct current input. A direct current source 704, in use, couples conductively via power pads 706 to the power pads 732 to supply a current that is used to charge electronic device 302. In some embodiments, power pads 706 and 732 are formed from opposite polarity magnetic masses. In such embodiment, those masses form the dual role of coupling the charger 704 to the wallet 700 and providing the path for current to flow between the charger 702 and the wallet 700. Electronics (not shown in this figure) within the wallet 700 control the flow of current from the power pads 732 to the transmit interface 322. The electronics further control the transmit interface 322 to cause it to induce a current in the receive interface 352 of the electronic device 302 when the wallet 700 is attached to the electronic device 302 and the charger 704 is powered and attached to the wallet 700. FIG. 7C shows the system in a stacked charging configuration. In this manner, the charger 704 can charge the electronic device 302 through the wallet 700 without detaching it from the electronic device.

Physically, the wallet 700 is very similar to wallet 300 (of FIGS. 3A-4) except that the receive interface in wallet 700 is a direct current interface rather than a Qi interface.

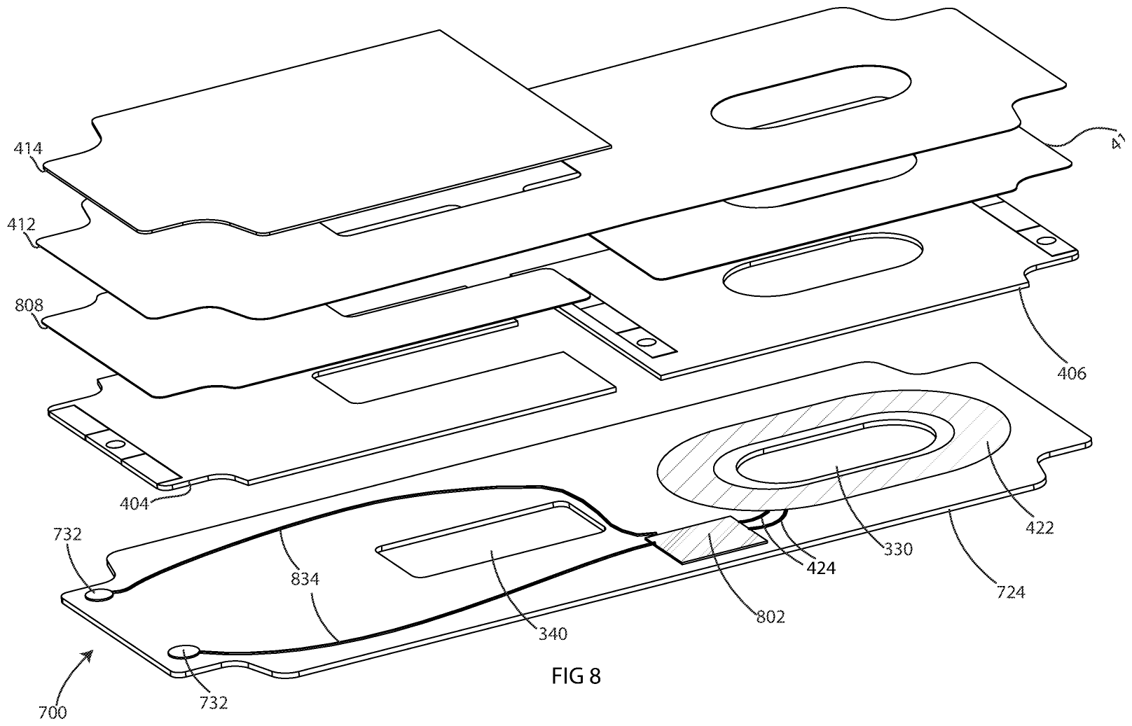

FIG. 8 is an exploded view of a wallet according to the embodiment of FIGS. 7A-7C. Like the embodiment described with reference to FIG. 4 above. This embodiment is a multilayer construction including many of the same components. The components having the same reference numbers are the same and not further described here in detail.

In one embodiment, outer body 724 has a transmit Qi coil 402 imbedded in or couple to an interior side of the device side surface. Power pads 732 that are exposed on the charger side surface are coupled to a control circuit 802 by a conductive path 834 that is coupled to or imbedded within the outer body 724. Control circuit 802 may include a current regulator as well as one or more charge storage devices such as capacitors or microbatteries and a Qi transmit controller. The Qi controller and the current regulator may be instantiated as one or more microcontrollers, one or more ASICs or the like. Transmit controller provides current modulation between the receive interface and the Qi transmit coil 422. The current regulator controls the current supplied to the transmit controller. Control circuit 802 is coupled to the Qi transmit coil 422 by conductive path 424, both of which are embedded in or coupled to the outer body 724.

The remaining layers of wallet 700 are the same as wallet 300 except that device side shield 810 need not provide the same level of ferromagnetic shielding as shield 410. The absence of a Qi receive coil on the charger side significantly reduces the risk of magnetic fields affecting the content of the internal volume. Suitable materials for charger side shield 808 include metal, foil coated plastic, foil coated cardboard, carbon filled composites, and combinations thereof. In some embodiments, charger side shield 808 may still be formed of the same materials as device side shield 410. Assembly of wallet 800 is substantially the same as described above in connection with wallet 300.

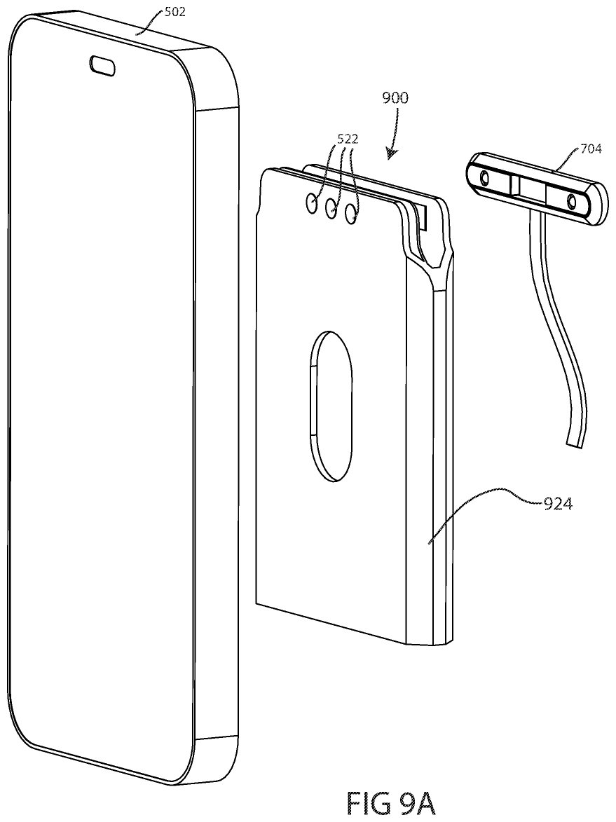

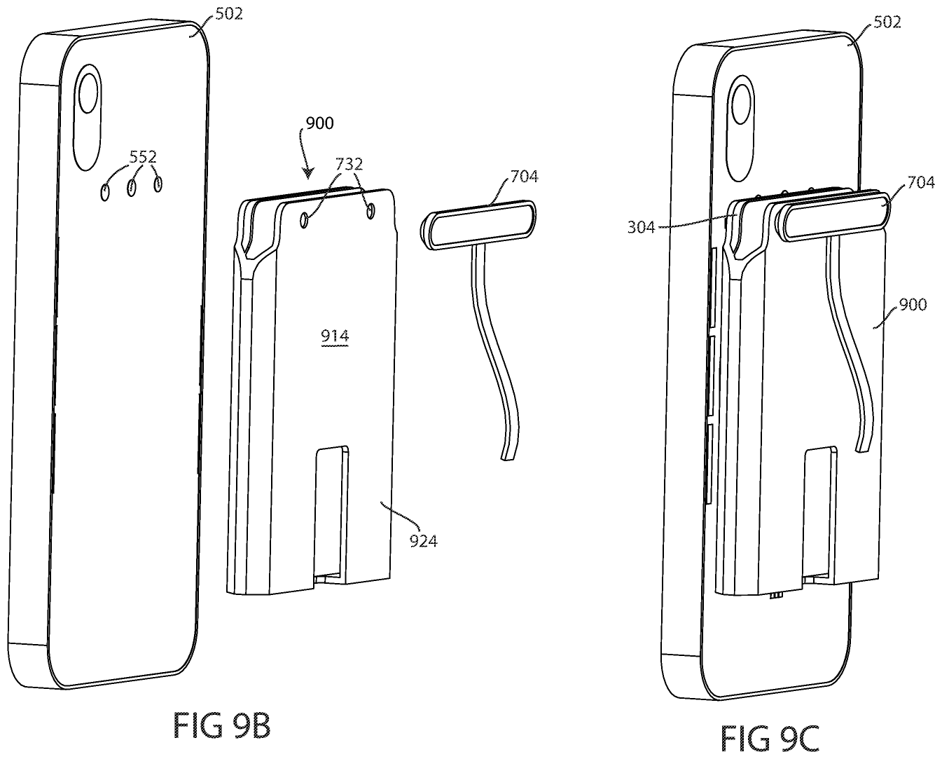

FIGS. 9A-9C are schematic diagrams of an inter-wallet charging system according to another embodiment of the invention. In some embodiments, electronic device 502 exposes a receiving interface 552 that includes a plurality of power pads on its surface. The power pads of receiving interface 552 accept a direct current to charge the internal battery of electronic device 502. Outer body 924 of wallet 900 may be formed of any of the previously describe materials. Outer body 924 exposes a corresponding set of power pads 522 of its transmit interface on its device facing surface 912 that can transmit a direct current input to the power pads 552 of the electronic device 502.

Wallet 900 exposes a set of power pads 732 of its receive interface at charger side surface 914 to receive a direct current input. A direct current source 704, in use, couples conductively to the power pads 732 to supply a current that is used to charge electronic device 302. Electronics (not shown in this figure) within the wallet 700 control the flow of current from the power pads 732 to power pads 522, which when conductively couple to the power pads of receiving interface 552 charge the electronic device 502. FIG. 3C shows the system in a stacked charging configuration. In this manner, the charger 704 can charge the electronic device 502 through the wallet 900 without removing it from the electronic device 502.

Physically, the wallet 900 is very similar to wallet 300 (of FIGS. 3A-4) except that both the transmit interface and the receive interface in wallet 900 are direct current interfaces rather than a Qi interfaces.

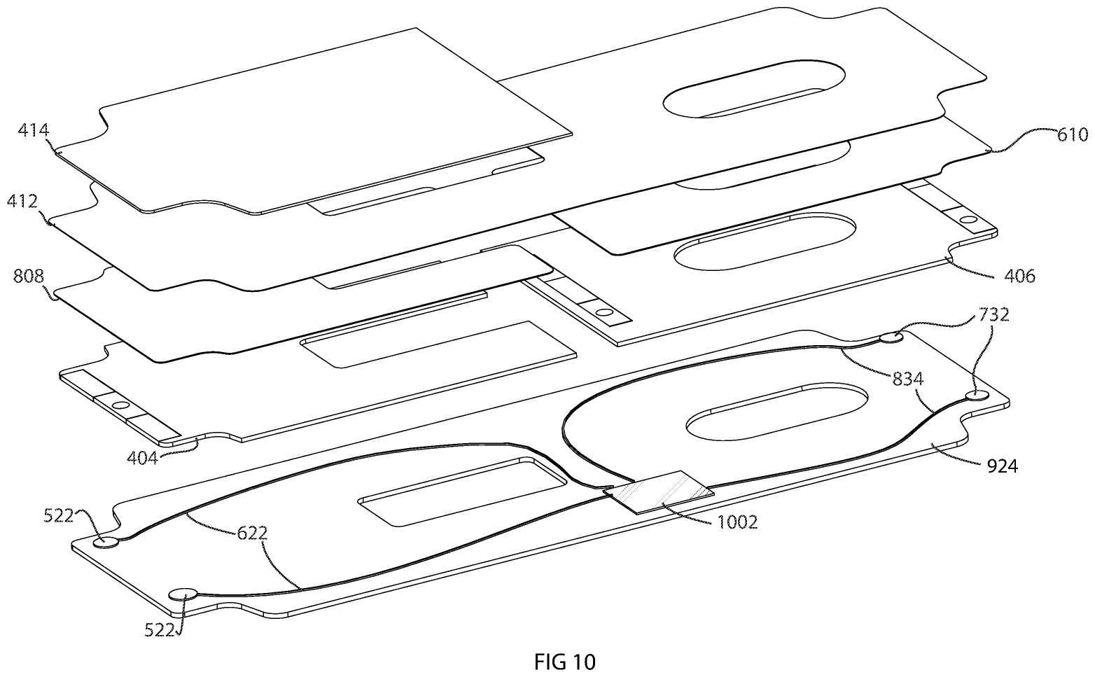

FIG. 10 is an exploded view of a wallet according to the embodiment of FIGS. 9A-9C. Like the embodiment described with reference to FIG. 4 above. This embodiment is a multilayer construction including many of the same components. The components having the same reference numbers are the same and not further described here in detail.

In one embodiment, outer body 924 has receive power pads 732 imbedded in or couple to be exposed on the exterior of the charger side surface. Power pads 732 are coupled to a control circuit 1002 by a conductive path 834 that is also coupled to or imbedded within the outer body 924. Control circuit 1002 may include one or more current regulators as well as one or more charge storage devices such as capacitors or microbatteries. The current regulators may be instantiated as one or more microcontrollers, one or more ASICs, discrete components or the like. The current regulator provides a controlled current to the power pads 522. Power pads 522 are imbedded in or couple to be exposed on the exterior of the device side surface of outer body 924. Control circuit 1002 is coupled to the power pads 522 by conductive path 622. Conductive path 622 is embedded in or coupled to the outer body 924.

The remaining layers of wallet 900 are the same as correspondingly number elements of earlier described embodiments. Assembly of wallet 900 is substantially the same as described above in connection with wallet 300.

While the wallets of embodiments of FIGS. 3-10 each describe a single transmit interface and a single receive interface, other embodiments may include more than one transmit interface and/or more than one receive interface. That is, some embodiments may include both a direct current transmit interface and a Qi transmit interface in the same wallet. Similarly, Some embodiment may include both a direct current receive interface and a Qi receive interface in the same wallet. Some embodiments may have one receive interface and two transmit interfaces or vice versa. Some embodiment may have two transmit interfaces and two receive interfaces. Where more than one interface is present, the internal electronics switch between/enable the current path that is sourcing or sinking current.

FIG. 11 is a schematic diagram of a wallet-electronic device interconnection system according to one embodiment of the invention. Electronic device 1102 provides magnetic coupling in a manner that assures alignment between its charging interface(s), direct current interface 1152 and Qi receive interface 1154 and corresponding interfaces on wallet 1100. Electronic device 1102, in various embodiment may have either or both of interfaces 1152, 1154. In one embodiment, electronic device 1102 may have incorporated in it a MagSafe® compliant magnetic connection scheme. This scheme includes a ring 1142 of magnetic masses that have alternating polarity regions. The ring 1142 assures axial alignment when coupled to a corresponding ring of an attached accessory such as wallet 1100. This scheme also includes a set of orientation magnets 1144. Like the ring adjacent regions in the orientation magnets 1144 expose alternating polarities regions at the surface of the electronic device 1102. Orientation magnets 1144 assure a single orientation of an attached accessory. In some embodiments, the MagSafe® scheme may be part of e.g., a phone case for the electronic device 1102 rather than being incorporated into the electronic device 1102 itself.

In an alternative embodiment, a plurality of magnetic masses 1160-1, 1160-2, . . . 1160-n (generically magnetic masses 1160) are arranged in a pattern (here a rectangle) to expose a magnetic field at the surface of electronic device 1102. It is preferred that the magnet masses 1160 alternate polarity so that adjacent masses 1160 expose opposite polarities. For example, the middle magnetic mass 1160-2, 1160-5, 1160-8, and 1160-11 in each row could each expose a north polarity and masses 1160-1, 1160-3, 1160-4, 1160-6, 1160-7, 1160-9, 1160-10 and 1160-12 could all expose a south polarity. It has been found that this alternating polarity arrangement significantly increases the strength of attraction over having a single polarity e.g., on the device and the opposite polarity on e.g., the wallet. In some embodiments, masses 1160 may form a pattern other than a rectangle e.g., a pentagon, hexagon, octagon or some other polygon. Additionally, the pattern may have a plurality of adjacent rows and the number of masses in a row is not limited to three. The number of masses is selected based on size of the masses and area of the electronic device. As used herein row is deemed to mean a linear arrangement of a plurality of masses regardless of orientation e.g. vertical, horizontal or diagonal. The pattern and the corresponding pattern on the accessory assure orientation and alignment of the respective charging interfaces. In some embodiments, the patterned scheme may be part of e.g., a phone case for the electronic device 1102 rather than being incorporated into the electronic device 1102 itself.

Wallet 1100 is shown employing the MagSafe® compliant coupling scheme. Magnetic ring 1132, in use, engages ring 1142 of mobile device 1102. Orientation magnet 1134 engages orientation segments 1144 thereby assuring alignment between the Qi transmit interface 1124 of the wallet 1100 and the Qi receive interface 1154 of the electronic device. Similarly, the power pads 1122 of the wallet 1100 is aligned with the power pads 1152 of the electronic device 1102. It should be understood that one of these interfaces could be omitted from either the wallet 1100 or the electronic device 1102, but as long as one corresponding pair of interfaces is present, charging through the wallet 1100 can occur. Instead of the Magsafe® compliant coupling some embodiments of wallet 1100 could use complementary rows of magnetic masses that engage at least a subset of masses 160 of mobile device 1102. The pattern of complementary magnet should be sufficient to assure orientation of the wallet to align at least one of the transmitting interface(s) of the wallet with a corresponding receiving interface of the mobile device 1102.

Generally, rare earth magnets such neodymium magnets have been found satisfactory for use in either magnetic coupling scheme. It is desirable that the strength of the magnetic bond be sufficiently strong that the neither the wallet nor the electronic device will separate if a user holds the stack by either component alone. That is, the magnetic force between the wallet and the electronic device should be sufficient to overcome the force of gravity on the electronic device when the wallet, alone, is held in any orientation. That same level of force has been found suitable to avoid dislodgement when the electronic device is stowed in a pocket or purse. It should explicitly be understood that various embodiments of the invention may use either or both of the schemes. Further, either or both schemes may be present on one or both of the electronic device and the connected wallet. While neither scheme is expressly shown on the embodiments discussed with reference to FIGS. 3A-10 either or both of these schemes could be used in any of these embodiments.

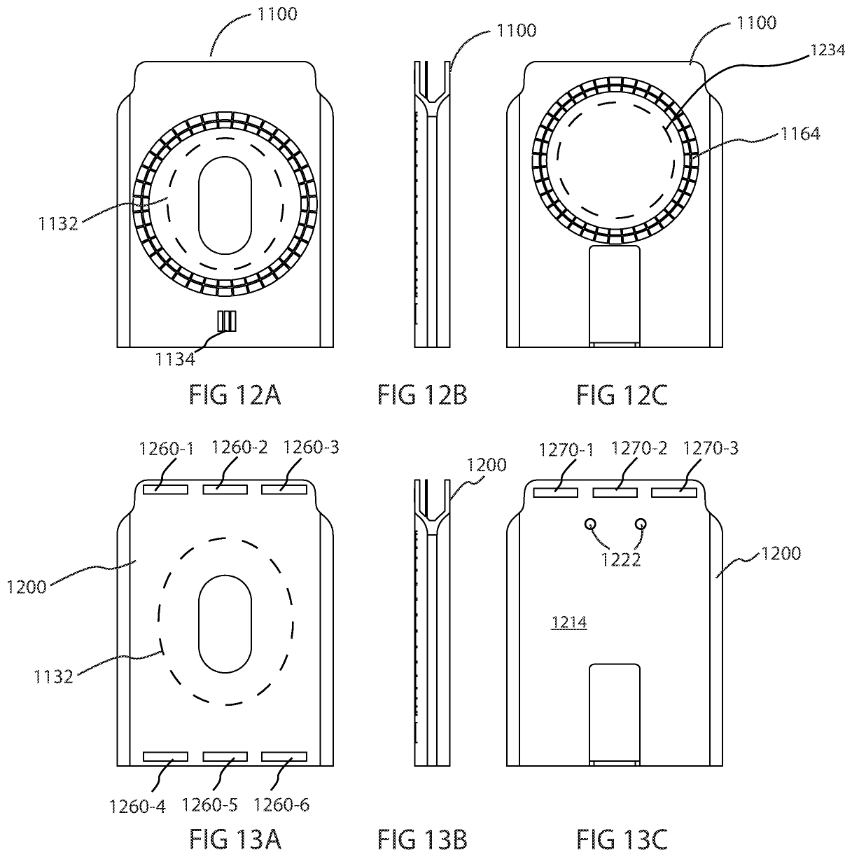

FIGS. 12A-12C are schematic diagrams showing a device side view, side view and charger side view of the wallet magnetic interconnection system of one embodiment of the invention. The device side 1112 of wallet 1100 is described above with respected to FIG. 11. The charger side 1114 exposes a MagSafe® compliant ring 1164 to engage a MagSafe® compliant Qi charger. The ring 1164 assures axial alignment between the charger and the receiving interface 1234 within the wallet 1100. It is not necessary to include an orientation magnet on the charger side surface as the Qi charger is radially agnostic.

FIGS. 13A-13C are schematic diagrams showing a device side view, side view and charger side view of the wallet magnetic interconnection system of another embodiment of the invention. Wallet 1200 uses the patterned magnetic scheme discussed above. Device side surface of wallet 1200 exposes magnetic fields from a plurality of magnetic masses 1260-1, 1260-2 . . . 1260-n (generically magnetic masses 1260) that are arrange in a pattern corresponding to a subset of the magnetic masses on the electronic device to which it will connect, e.g., masses 1160 of electronic device 1102. Here two rows of magnetic masses 1260 are shown exposing fields at surface 1212. These rows could connect to either the vertical or the horizontal rows on device 1102 so the wallet 1200 would reside in either a landscape or portrait orientation respectively. In either orientation, Qi transmit interface 1132 would align with the Qi receive interface of the host electronic device. Magnetic masses 1260 should follow the opposite polarity sequence of the corresponding rows on the host electronic device. For example, the middle magnetic mass 1260-2, 1260-5 in each row could expose a south polarity and the remaining masses 1260-1, 1260-3, 1260-4 and 1260-6 could expose a north polarity.

The charger side surface 1214 of wallet 1200 exposes magnetic fields from a plurality of magnetic masses 1270-1, 1270-2, 1270-3 (generically magnetic masses 1270). More or fewer magnetic masses 1270 may be used in various embodiments. In one embodiment, immediately adjacent magnetic masses 1270 expose opposite polarity magnetic fields. Magnetic masses 1270, in use, engage corresponding masses in a direct current charger (not shown) to retain the power pads of the charger in electrical communication with the power pads 1222 exposed on charger side 1214 of wallet 1200.

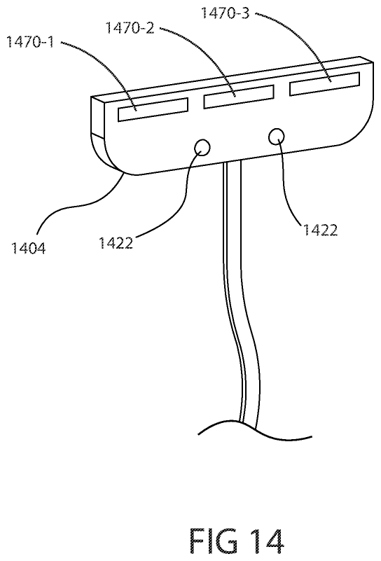

FIG. 14 is a schematic diagram of a charger with an interconnection system according to one embodiment of the invention. Charger 1404 exposes power pads 1422 that can conductively engage e.g., power pads 1222 of wallet 1200. A plurality of magnet masses 1470-1, 1470-2, 1470-n (generically magnetic masses 1470) to are dispose in charger 1402 in a pattern that is complementary to e.g., magnetic masses 1270. This assures alignment of the power pad 1422 with the corresponding power pads on the attached wallet.

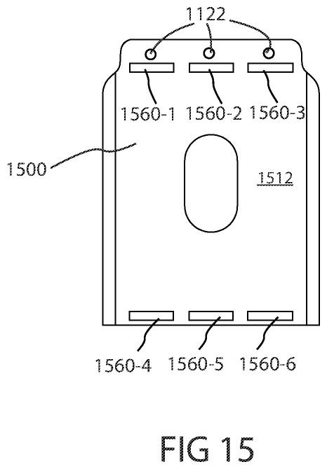

FIG. 15 shows a device side of a wallet with a direct current interface with linear magnetic interconnections. Device side surface 1512 of wallet 1500 exposes a set of power pads 1122 configured to electrically engage e.g., power pads 1152 of mobile device 1102. To ensure that alignment, an arrangement of magnetic masses 1560-1, 1560-2, 1560-n (generically magnetic masses 1560) in wallet 1500 expose a magnetic field complementary to e.g., a subset of magnetic masses 1160. In the shown example, magnetic masses expose a complementary magnetic field to masses 1160-1, 1160-2, 1160-3 and 1160-7, 1160-8 and 1160-9. Wallet 1500 would reside in portrait orientation on mobile device 1102 and the direct current charging interfaces are aligned.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A wallet to be connected to an electronic device comprising:
a body defining an internal volume, the body having a first external side and a second external side, the body defining an ingress/egress opening on one edge of the body;
a first Qi coil exposed proximate to the first side;
a ferromagnetic shield disposed between the first Qi coil and the internal volume; and
at least one of a second Qi coil and a set of power pads exposed proximate to the second side.

2. The wallet of claim 1 further comprising:
a set of magnets coupled to the body in a pattern to assure a known orientation of the body when proximate to a complementary set of magnets associated with the electronic device.

3. The wallet of claim 1 wherein the first Qi coil is a transmit coil and the second Qi coil is a receive coil, the wallet further comprising:
a second ferromagnetic shield disposed between the second Qi coil and the internal volume.

4. The wallet of claim 3 further comprising:
transmit electronics coupled to the transmit Qi coil to drive the transmit Qi coil; and
receive electronics coupled to the receive Qi coil to drive the receive Qi coil.

5. The wallet of claim 2 wherein the first coil is a receive Qi coil and wherein the known orientation causes the set of power pads to align with a second set of power pads associated with the electronic device.

6. The wallet of claim 2 further comprising:
a liner inside the body providing electromagnetic shielding for the internal volume.

7. The wallet of claim 2 further comprising:
a second set of magnets coupled to the body, the second set of magnets arranged in a pattern to assure a known orientation relative to a power source when proximate to a second complementary set of magnets associated with the power source.

8. The wallet of claim 1 wherein the first Qi coil is a transmit coil, the wallet further comprising:
a power storage unit coupled to the transmit coil, the power storage unit to energize the transmit coil responsive to one of powering of the second Qi coil of application of power to the set of power pads.

9. The wallet of claim 1 further comprising:
a first set of mechanical fasteners attached to the body to couple the body to the electronic device in a known orientation.

10. The wallet of claim 1 further comprising a divider within the internal volume that segregates the internal volume into two compartments.

11. The wallet of claim 1 wherein at least one of the first external side and the second external side define a void that permits access to the internal volume through the respective side.

12. The wallet of claim 8 further comprising:
a set of magnets coupled to the body in a pattern to assure a known orientation of the body when proximate to a complementary set of magnets associated with the electronic device.

13. The wallet of claim 10 further comprising:
a first set of mechanical fasteners attached to the body to couple the body to the electronic device in a known orientation.

14. A wallet to be connected to an electronic device comprising:
a body defining an internal volume, the body having a first external side and a second external side;
a first set of power pads exposed on the first external side;
a second set of power pads exposed on the second external side; and
a conductive path within the body coupling the first set of conductive pads to the second set of conductive pads.

15. A system for charging an electronic device comprising:
a power base; and
a wallet having a first side proving a first interface for power connection to the electronic device, a second side providing a second interface for power connection with the power base, and a conductive path between the first interface and the second interface.

16. The system of claim 15 wherein the wallet further comprises:
a set of magnetic masses arranged in a pattern to assure registration between the first interface and a charging interface on the electronic device.

17. The system of claim 15 wherein the wallet further comprises:
a set of magnetic masses arranged in a pattern to assure registration between the second interface and a charging interface on the power base.

18. The system of claim 15 wherein the first interface comprises:
a transmit Qi coil; and
a current modulator driving the transmit Qi coil.

19. The system of claim 15 wherein the first interface comprises:
a set of power pads that in use electrically couple to a charging interface of the electronic device.
